(19) United States
(12) Patent Application Publication
(10) Pub. No.: US 2023/0169852 A1
(43) Pub. Date: Jun. 1, 2023

(54) Method, system and program product for training a computer-implemented system for predicting future developments of a traffic scene

(71) Applicant: Robert Bosch GmbH, Stuttgart (DE)

(72) Inventors: Faris Janjos, Stuttgart (DE); Maxim Dolgov, Renningen (DE)

(21) Appl. No.: 17/989,079

(22) Filed: Nov. 17, 2022

(30) Foreign Application Priority Data
Nov. 30, 2021 (DE) 102021213482.3

(51) Int. Cl. G08G 1/01; G06N 5/022; G06N 3/08

(52) U.S. Cl. CPC G08G 1/0133; G08G 1/0129; G06N 5/022; G06N 3/08

(57) ABSTRACT

A method for training a computer-implemented system for predicting future developments of a traffic scene is proposed, the system comprising at least a perception level for aggregating scene-specific information of an input scene, a backbone network for generating a feature set of latent features based on the scene-specific information, a classifier network that evaluates a specified number of different modes for the future developments of the input scene based on the feature set, and for each mode, a prediction module for generating a prediction for the future development of the input scene. According to the disclosure, the backbone network is trained along with the classifier network by modifying the weights of the backbone network and/or the weights of the classifier network such that a deviation between the learning phase evaluation of the classifier network and a realistic evaluation of the different modes is reduced.

This application claims priority under 35 U.S.C. § 119 to patent application no. DE 10 2021 213 482.3, filed on Nov. 30, 2021 in Germany, the disclosure of which is incorporated herein by reference in its entirety.

The disclosure relates to a method for training a computer-implemented system for predicting future developments of a traffic scene as well as to a corresponding system and a corresponding program product.

### BACKGROUND

The prediction of future developments of a traffic scene can be used in the context of stationary applications, e.g., in a permanently installed traffic control system, which monitors the traffic situation in a defined spatial area. Based on the prediction, such a traffic control system can then provide corresponding information and, if appropriate, also driving recommendations at an early stage in order to control the flow of traffic in the monitored area and in its vicinity.

Another important field of application for the computer-implemented system and method for predicting future developments of a traffic scene in question here are mobile applications, e.g., vehicles with assistance functions. Automated vehicles not only need to capture the traffic situation they are currently in but also to anticipate how this traffic situation will develop, in order to be able to plan safe and comprehensible maneuvers.

Traditional prediction methods generally perform prediction based on kinematics/dynamics. These approaches provide a prediction that is usually only meaningful for a very short time, e.g., for less than 2 s. For this reason, in recent years, the use of machine learning, in particular deep learning (DL), has been established as the de facto standard for prediction. In order to represent a traffic scene, binary or color-coded top-down grids, graph representations, and/or lidar reflexes are often used. As a prediction of future developments of a traffic scene, future trajectories of the involved traffic participants, i.e., vehicles, cyclists, pedestrians, etc., are usually predicted.

A multi-modal prediction in which multiple mode-specific trajectories are predicted for each traffic participant is known. In this case, each trajectory represents a possible future behavior of the respective traffic participant, but without considering the behaviors of the remaining traffic participants. Consequently, any interactions occurring between the traffic participants are also not considered. Such multi-modal prediction therefore disregards the development of the input scene in its entirety. This proves to be problematic in several respects. For instance, the computational effort is very high and in part unnecessary because trajectories that are not compatible with the trajectories of other traffic participants are generally also calculated for each traffic participant. In addition, such a prediction is only conditionally meaningful and, for example, can at best be used for planning components of an automated vehicle to a limited extent.

### SUMMARY

A high significance of the prediction with meaningfully limited computational effort can be achieved with a computer-implemented system for predicting future developments of a traffic scene, which comprises at least the following components:
a perception level for aggregating scene-specific information of an input scene,
a backbone network for generating a feature set of latent features based on the scene-specific information,
a classifier that evaluates a specified number of different modes for future developments of the input scene based on the feature set, and
for each mode, a prediction module for generating a prediction for the future development of the input scene, wherein at least one prediction module can optionally be activated.

Accordingly, the system in question here has a multi-stage architecture. In a first stage, the input scene is characterized on the basis of a feature set obtained based on scene-specific information—perception level in connection with the backbone network. In a second stage, the uncertainty about the future development of the input scene is evaluated by evaluating different modes for the future development of the input scene based on the feature set—classifier. A third stage comprises the optionally activatable prediction modules associated with the individual modes. When activated, each of these prediction modules respectively provides only a single trajectory or a set of similar trajectories for each traffic participant of the input scene as a prediction, these similar trajectories then being based on a common intension for the development of the input scene. In this case, a trajectory can be described in deterministic or probabilistic form or in the form of samples.

With the aid of this multi-stage architecture, it is very easy to identify individual modes that represent a “meaningful” development of the input scene, i.e., meet a specified selection criterion. If then only the corresponding prediction modules are activated, only predictions for meaningful developments of the input scene are generated. This contributes substantially to the significance of the prediction. In addition, the computational effort can thus easily be kept within limits.

Accordingly, the system in question here provides a multi-modal prediction, which does not relate to all possible future behaviors of each individual traffic participant of the input scene, like the multi-modal prediction known from the prior art, but rather to a plurality of different modes for the development of the input scene in its entirety.

The concept described above is also the basis for a computer-implemented method for predicting future developments of a traffic scene, the method comprising at least the following steps:
aggregating scene-specific information of an input scene,
generating at least one feature set of latent features based on the scene-specific information with the aid of a backbone network,
evaluating a specified number of different modes for the future developments of the input scene based on the feature set with the aid of a classifier,
selecting at least one mode based on the evaluation by the classifier and activating at least one prediction module associated with the selected mode, and
generating a prediction for the future development of the input scene with the aid of the at least one activated prediction module.

As already mentioned, the optionally activatable prediction modules of the corresponding system are advantageously activated depending on the evaluation of the associated mode carried out by the classifier. For example, the classifier could carry out a binary evaluation of the individual modes in the sense of “plausible development” or “excludable development.” Alternatively, the classifier could also assign a normalized or non-normalized score to each mode. In this case, the decision about activation of the associated prediction module could be made depending on the threshold value, or also by comparison or rating if a fixed number of prediction modules to be activated is specified.

In principle, such a computer-implemented system comprises at least two prediction modules for at least two different modes, i.e., a respective prediction module for each mode. These may be prediction modules of the same or different types as long as each prediction module provides, for each traffic participant in the input scene, a trajectory prediction for a particular combination of intentions of all traffic participants in the input scene. The classifier evaluates the different modes independently of the type of the associated prediction module. Activation of the individual prediction modules also takes place type-independently.

In a preferred variant, the computer-implemented system comprises at least one prediction module that is realized in the form of a scene anchor network (SAN) and, if activated, generates a prediction for the future development of the input scene based on the feature set provided by the backbone network. Advantageously, such a SAN is trained along with other components of the system, e.g., along with the backbone network and/or the classifier, in order to optimize the prediction with respect to the intended application of the system.

It is of particular advantage that the system architecture in question here also enables the integration of model-based prediction modules and/or prediction modules in the form of pre-trained prediction networks. These prediction modules will generally not be able to use the feature set provided by the backbone network for the prediction. Instead, they can resort to the perception level and generate a prediction based on the scene-specific information. The use of model-based prediction modules may advantageously contribute to limiting the computational effort for the prediction.

The system in question here comprises a perception level for aggregating scene-specific information of an input scene. Advantageously, this scene-specific information includes semantic information about the input scene, in particular map information. This semantic information may be provided locally, e.g., from a local storage unit, or may be centrally retrievable, e.g., via a cloud. Furthermore, the scene-specific information advantageously includes information about traffic participants in the input scene. Information about the current state of movement and/or the traveled trajectory of the individual traffic participants is of particular interest. Such information can be captured and provided by sensor systems, for example, comprising sensors, such as video, LIDAR and radar, or also GPS (Global Positioning System) in connection with traditional inertial sensors.

The aggregated scene-specific information must then be converted into a data representation processable by the backbone network, which preferably also takes place in the perception level. In an advantageous variant of the disclosure, the scene-specific information is additionally also converted into a data representation processable by a pre-trained prediction network, i.e., the perception level provides several different data representations of the scene-specific information. If the backbone network and/or a pre-trained prediction network is realized in the form of a graph neural network (GNN), the scene-specific information is converted into a graph representation. If the backbone network or the pre-trained prediction network is a convolutional neural network (CNN), the scene-specific information is converted into a grid representation or, if appropriate, a voxel grid representation.

The disclosure in question here assumes that the classifier of the system described above is realized in the form of a neural network that evaluates a specified number of different modes for the future developments of the input scene based on the feature set provided by the backbone network. Accordingly, the type of the classifier network must be selected according to the data representation of the feature set provided by the backbone network. If the backbone network generates a feature set in the form of a feature vector, the classifier is advantageously realized in the form of a feed forward neural network.

With the disclosure, measures for training such a computer-implemented system described above to predict future developments of a traffic scene are proposed.

Accordingly, the subject matter of the disclosure is a method for training a computer-implemented system for predicting future developments of a traffic scene, the system comprising at least:

a. a perception level for aggregating scene-specific information of an input scene,

b. a backbone network for generating a feature set of latent features based on the scene-specific information,

c. a classifier network that evaluates a specified number of different modes for the future developments of the input scene based on the feature set, and

d. for each mode, a prediction module for generating a prediction for the future development of the input scene.

Within the scope of this method, the backbone network generates a learning phase feature set based on scene-specific training data. The classifier network then generates a learning phase evaluation of the different modes based on the learning phase feature set. In addition, each prediction module generates a prediction for the future development of the input scene. For each prediction module, the deviation of the respective prediction from the actual development of the input scene is then determined in order to derive a realistic evaluation of the associated mode from this deviation.

According to the disclosure, the backbone network is trained along with the classifier network by modifying the weights of the backbone network and/or the weights of the classifier network such that a deviation between the learning phase evaluation and the realistic evaluation of the different modes is reduced.

In an advantageous embodiment of the disclosure, each prediction module for each traffic participant in the input scene generates a deterministic and/or probabilistic prediction trajectory as a prediction for the future development of the input scene. Then, for each of these traffic participants, the deviation between the prediction trajectory and the actual trajectory is determined in order to derive, based on the deviations determined in this way, a realistic evaluation of the mode associated with the respective prediction module.

A particular advantage of the training method according to the disclosure is that it can be used for a wide variety of system configurations in terms of the implementation of the prediction modules.

For example, if one or more prediction modules are realized in the form of a pre-trained prediction network or in the form of a model-based prediction module, these prediction modules, if compatible, may use the learning phase feature set or also simply the training data in order to generate a prediction action for the future development of the input scene.

However, the method according to the disclosure is also suitable for training the backbone network and the classifier network along with at least one previously untrained prediction network. In this case, it is provided
that the at least one untrained prediction network generates a learning phase prediction for the future development of the input scene based on the training data and/or the learning phase feature set,
that the deviation of the learning phase prediction from the actual development of the input scene is determined and that a realistic evaluation of the associated mode is derived from the deviation, and
that the weights of the backbone network and/or the weights of the classifier network and/or the weights of the at least one untrained prediction network are modified such that a deviation between the learning phase evaluation and the realistic evaluation of the different modes is reduced.

In order to prevent the scenes predicted by the prediction networks to be trained from becoming too similar to one another, it is recommended to consider a further criterion when modifying the weights, namely, an entropy of the predicted scenes. In an advantageous variant of the training method, the weights of the backbone network and/or the weights of the classifier network and/or the weights of the at least one untrained prediction network are thus modified not only such that a deviation between the learning phase evaluation and the realistic evaluation of the different modes is reduced but also such that an entropy of the predictions of the prediction modules is increased. Again, all predictions, i.e., the predictions of the prediction networks to be trained as well as of the pre-trained and traditional prediction modules, are considered.

### BRIEF DESCRIPTION OF THE DRAWINGS

Advantageous embodiments and developments of the disclosure are discussed below with reference to the figures.

FIGS. 1a) to 1d) illustrate possible meaningful developments of a traffic scene 10 at a T intersection.

FIG. 2 shows a schematic diagram of a first variant of the system according to the disclosure for predicting future developments of a traffic scene.

FIG. 3 shows a schematic diagram of a second variant of a system to be trained.

FIG. 4 illustrates the training method according to the present disclosure in the event of a system comprising only traditional prediction modules and pre-trained prediction networks.

FIG. 5 illustrates the training method according to the disclosure in the event of a system comprising an untrained prediction network in addition to traditional prediction modules and a pre-trained prediction network.

### DETAILED DESCRIPTION

As already explained above, the system in question here provides a multi-modal prediction that relates to a plurality of different modes for the possible meaningful developments of a traffic input scene. In doing so, the possible developments of the input scene are considered as a whole, i.e., not only at the level of each individual traffic participant, by, for example, also considering interactions between the traffic participants of the input scene and the right of way rules.

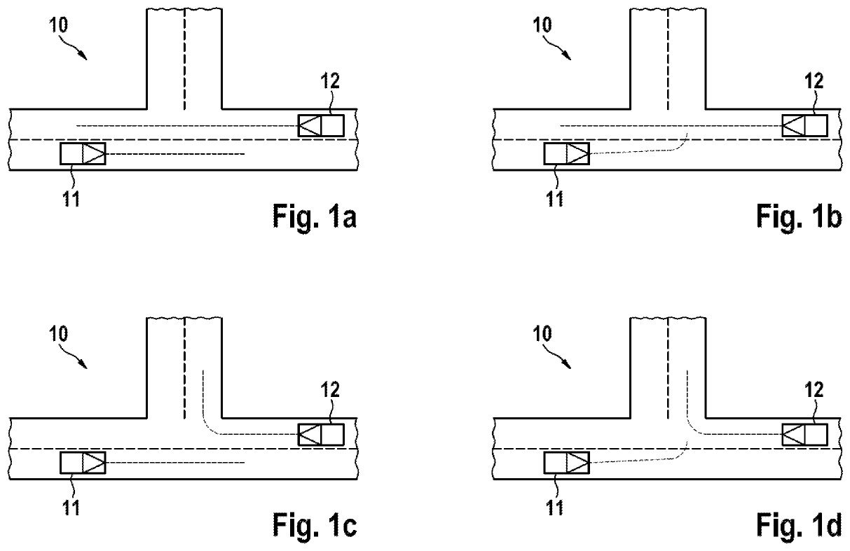

This is illustrated by FIGS. 1a) to 1d). They illustrate four possible meaningful developments of a traffic scene 10 at a T intersection, in which two vehicles 11 and 12 are involved. In FIGS. 1b and 1d, vehicle 11 interacts with vehicle 12 by observing the right of way rules when turning left. Depending on the distance of the two vehicles 11 and 12 to the intersection, a prediction in which vehicle 11 disregards the right of way or cuts off vehicle 12 would not be meaningful or at least less likely.

For illustration purposes, in the exemplary embodiment described below, each of the possible developments of the input scene shown in FIGS. 1a) to 1d) is associated with a mode and a prediction module.

However, it is expressly pointed out at this point that the system in question here assumes a specified number of modes and, accordingly, also comprises only a specified number of prediction modules. For this reason, several, if appropriate very different, possible developments of the input scene are usually combined in one mode and evaluated by the classifier. For example, a system according to the disclosure could also provide only two modes and correspondingly two different prediction modules in order to recognize the context of “autobahn travel” and to carry out a prediction for the context of “autobahn travel” or, alternatively, for a context of “non-autobahn travel.”

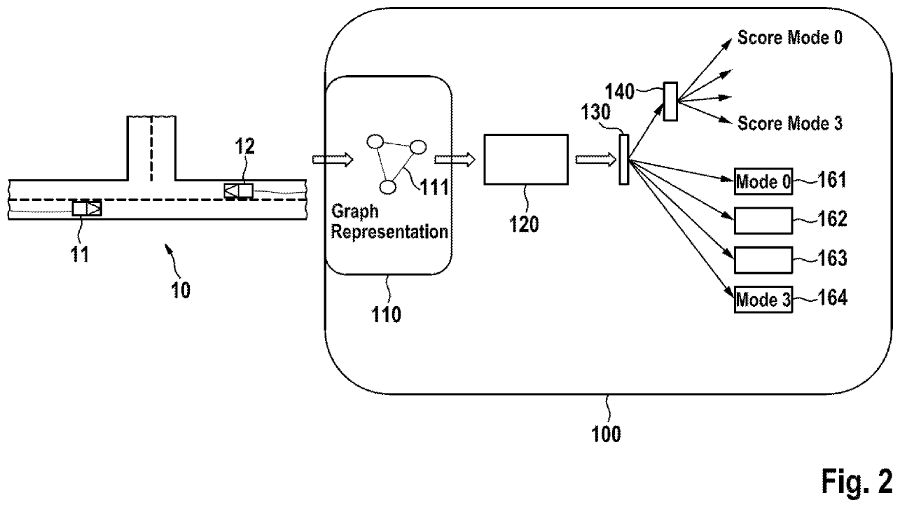

The diagram in FIG. 2 illustrates the multi-stage architecture as well as the mode of operation of a system 100 in question here for predicting future developments of a traffic scene, here the traffic scene 10, which forms the input scene.

The system 100 is equipped with a perception level 110 for aggregating scene-specific information of the input scene 10. The scene-specific information includes map information and so-called object lists with information about the current state of the traffic participants involved, here vehicles 11 and 12. Furthermore, the scene-specific information includes historical data, here the trajectories traveled by vehicles 11 and 12. In the exemplary embodiment described here, the aggregated scene-specific information at the perception level 110 is converted into a graph representation 111 and is fed in this format to a backbone network 120 realized in the form of a graph neural network (GNN).

In addition to the described graph representation, a grid representation can also be generated from an object list, historical data, and map information. In this case, the backbone network should preferably be designed in the form of a convolutional neural network (CNN). The scene-specific information can also be in the form of lidar reflexes from the current as well as previous recordings of the input scene. In this case, a data representation in the form of a voxel grid may be appropriate. In principle, the scene-specific information can be converted into any data representation that allows either all or at least the relevant objects in the input scene as well as the semantic scene information to be represented and that is compatible with the structure or type of the backbone network.

In the present case, based on the graph representation 111 of the scene-specific information, the backbone network 120 generates a feature vector 130 of latent features that characterize the input scene.

The feature vector 130 is fed to a classifier 140, which is realized in the form of a feed forward neural network in the present exemplary embodiment. Based on the feature vector 130, the classifier 140 evaluates a specified number of different modes for the possible future developments of the input scene 10. As already explained in connection with FIGS. 1a) to 1d), four different modes corresponding to the four different meaningful possible developments of the input scene 10 are available to the system 100 described here. In order to evaluate the individual modes, the classifier 140 generates a vector consisting of the individual scores for the different modes, based on the feature vector 130. Subsequently, the modes whose scores are above or below a threshold value are selected as relevant. However, based on the scores, the N best modes, i.e., the N modes with the highest scores, may, for example, also be selected. In this way, at the stage of classifier 140, less likely developments of the input scene can already be excluded from the prediction, e.g., in the present case, that the right of way rules are disregarded or that vehicle 11 cuts off vehicle 12.

For each mode, the system 100 according to the disclosure comprises a prediction module 161 to 164, wherein at least one of these prediction modules 161 to 164 is optionally activatable. In the event of activation, each prediction module 161 to 164 generates a prediction for the future development of the input scene. Each prediction comprises a respective trajectory for each traffic participant of the input scene, i.e., here for vehicles 11 and 12. These trajectories may be described deterministically by indicating a respective state value (position, orientation, speed, acceleration, etc.) for each time point of the predicted trajectory. However, the trajectories may also be determined probabilistically, e.g., in the form of a Gaussian density, for each time point of the predicted trajectory, i.e., by means of the mean value of the state as well as the associated covariance. Also possible is a non-parametric probabilistic trajectory representation in the form of samples from the predicted distribution.

In the exemplary embodiment shown in FIG. 2, all four prediction modules are optionally activatable scene anchor networks (SANs) that are parameterized with the feature vector 130. In the present case, only the SANs whose modes have been selected based on the evaluation of the classifier 140 are thus activated. And each of these activated SANs respectively generates a prediction for the future development of the input scene based on the feature vector 130 provided by the backbone network 120.

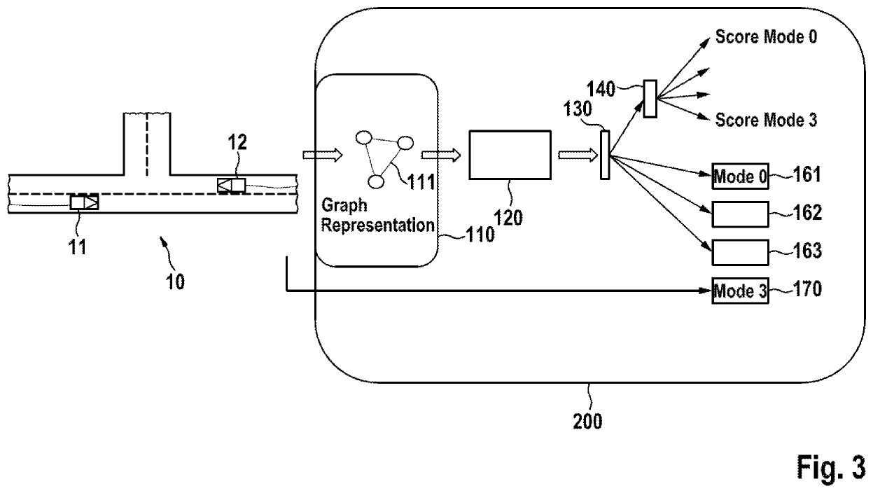

The system 200 shown in FIG. 3 differs from the system 100 shown in FIG. 2 only in the constellation of the four prediction modules. In the case of the system 200, only three prediction modules 161 to 163 are realized in the form of SANs, which are parameterized with the feature vector 130. A traditional model-based prediction module 170 is provided here for one of the four modes. The prediction module 170 is parameterized with the scene-specific information aggregated at the perception level 110. That is to say, the prediction module 170 generates a prediction for the future development of the input scene based on the scene-specific information.

The exemplary embodiments described above illustrate the essential aspects of the system and of the corresponding method for predicting future developments of a traffic scene. The system architecture is based on a set of optionally activatable prediction modules, each of which provides one or more trajectory predictions for each traffic participant in the input scene for a particular combination of intentions of the traffic participants in the scene. Advantageously, SANs (scene anchor networks) are used as prediction modules, but traditional prediction modules or separately trained DL-based prediction modules may also be included. Moreover, a classifier in the form of a neural network is provided, which provides an evaluation, for example a score, for each prediction module. This score serves as a measure of how plausible the prediction of the particular prediction module is. Without limiting generality, such a score may be normalized. At run time, not all prediction modules are executed, but rather only the ones whose evaluation meets a specified selection criterion. This has the advantage that predictions are only generated for meaningful developments of the input scene. It is of particular advantage that the proposed system architecture allows the combination of DL-based and traditional prediction by being able to use other, for example planning-based, prediction modules in addition to SANs. These other prediction modules may already be included in the training of the classifier network. In this way, the classifier network learns to also evaluate traditional prediction modules in addition to DL-based prediction modules and to select them at run time, if their use makes sense.

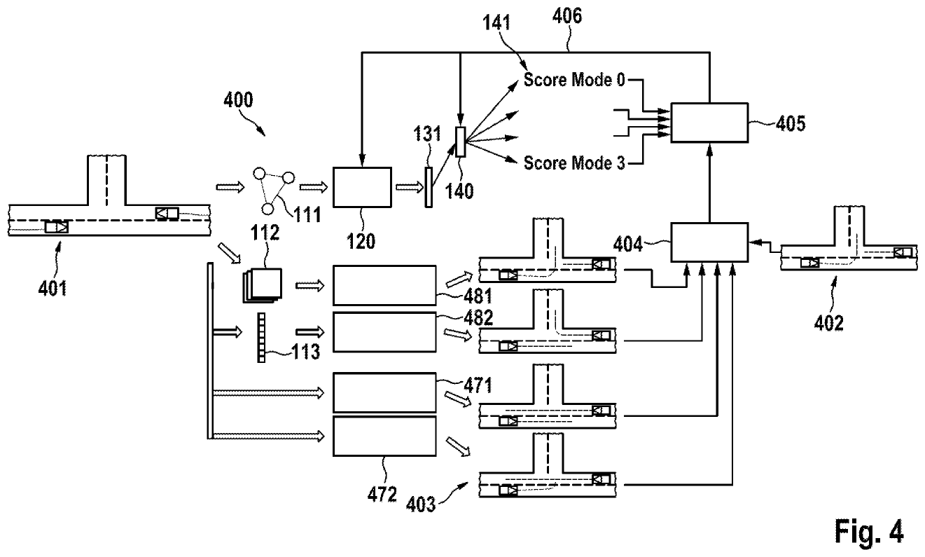

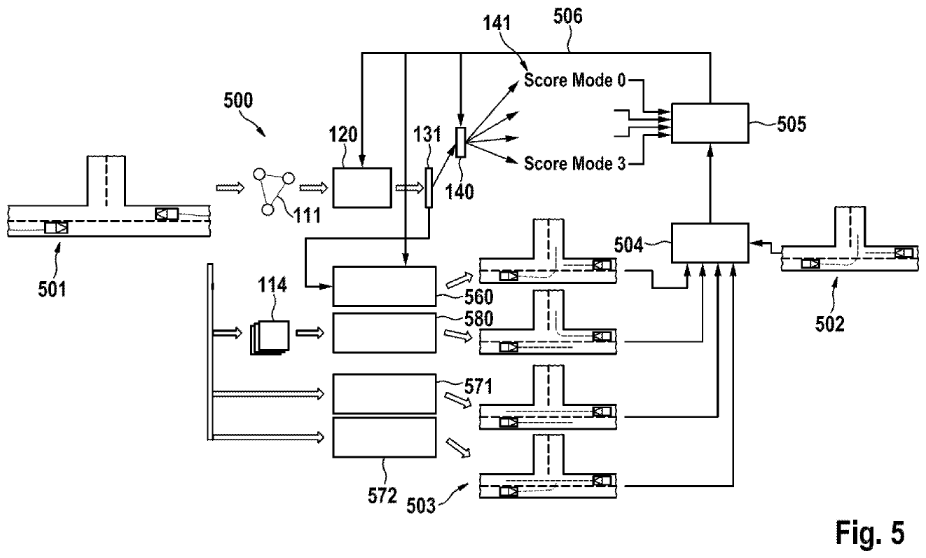

According to the possibilities for variation in the architecture of the system according to the disclosure, there are also different approaches for training such a system, which is explained in more detail below with reference to FIGS. 4 and 5.

Common to the different training approaches is that the backbone network 120 generates a learning phase feature set 131 based on scene-specific training data 401 and 501, respectively. The classifier network 140 then generates a learning phase evaluation 141 of the different modes based on the learning phase feature set 131. In addition, each prediction module generates a prediction 403 and 503, respectively, for the future development of the input scene specified by the training data 401 and 501, respectively. Then, for each prediction module, the deviation of the respective prediction from the actual development of the input scene is determined and a realistic evaluation of the associated mode is derived from the deviation—404 and 504, respectively. For example, the realistic evaluation of a mode may be defined as an inverse of the deviation.

In addition, in the different training approaches, the backbone network 120 is always trained along with the classifier network 140 by modifying the weights of the backbone network 120 and/or the weights of the classifier network 140 such—406 and 506, respectively that a deviation between the learning phase evaluation and the realistic evaluation of the different modes is reduced, which is enabled by calculating and evaluating a so-called loss function—405 and 505, respectively.

As already explained extensively in connection with the system according to the disclosure, each prediction module generates, as a prediction for the future development of the input scene, one or more deterministic and/or probabilistic prediction trajectories for each traffic participant in the input scene as a future development of the input scene. These prediction trajectories are collectively designated in FIGS. 4 and 5 with reference numerals 403 and 503, respectively. As part of the training method, the deviation between the prediction trajectories and the actual trajectories, i.e., the so-called ground truth trajectories, 402 and 502, respectively, of the traffic participants from the input scene is respectively determined.

Then, based on the deviations thus determined, a realistic evaluation of the mode associated with the respective prediction module is derived.

When using the following notation:

τᵢ^{k} Trajectory predicted by the network/traditional model k for the vehicle i,

\hat{τ}ᵢ Ground-truth trajectory of the vehicle i (contained in data),

τᵢ^{k}(t) Position of the vehicle at the time t in the predicted trajectory τᵢ^{k},

T Prediction horizon for trajectories,

M Number of vehicles in the scene,

N Number of SANs being trained,

L Number of traditional models/pre-trained networks,

σ^{k} Classifier Score for model/SAN k,

the following measure of the distance between prediction trajectories and actual trajectories, or ground-truth trajectories, can be defined:

$${d}^{k} = {\sum }_{i = 1}^{M} {\sum }_{t = 0}^{T} {( {τ}_{i}^{k} ( t ) - {\hat{τ}}_{i} ( t ) )}^{2}$$

FIG. 4 shows the case of a system 400 to be trained, which comprises only prediction modules in the form of pre-trained prediction networks 481, 482 or in the form of traditional model-based prediction modules 471, 472. All four prediction modules 481, 482, 471, 472 generate a prediction for the future development of the input scene based on the training data 401, i.e., independently of the learning phase feature set 131 provided by the backbone network 120. In the exemplary embodiment shown here, the training data 401 at least for the pre-trained prediction networks 481, 482 are still converted into a suitable data representation 112 and 113, such as a vector created according to a particular arrangement of the elements of a scene, or bird's eye view.

If only the classifier network 140 is trained with parameters θ in connection with the backbone network 120, the loss function

$${J}_{s} ( θ ) = - {\sum }_{k = 1}^{L} {( {σ}^{k} - \frac{1}{{d}^{k}} )}^{2}$$

can be used. Accordingly, the goal of the training method is to define the scores 141 such that they are inversely proportional to the distances of the predicted trajectories 403 to the ground-truth 402, i.e., the actual, trajectories. In this way, the prediction models that can best predict a scene get the best score. Index s in Jₛ stands for scene s. The total loss function is the sum across all the scenes in the training data set.

FIG. 5 shows the case of a system 500 to be trained, which also comprises a prediction network 560 to be trained in addition to a pre-trained prediction network 580 and two traditional prediction modules 571, 572. While the prediction modules 580, 571, and 572 generate a prediction for the future development of the input scene based on the training data 501, if appropriate in a suitable data representation 114, the prediction network 560 to be trained uses the learning phase feature set 131 as the basis for prediction. The previously untrained prediction network 560 is trained here along with the backbone network 120 and the classifier network 140. As a result, a meaningful diversity can rather be found for the feature set 131 of latent features, which is significant both for the classifier 140, i.e., the characterization and evaluation of the different modes, and for the prediction.

In this case, the training method additionally provides that the untrained prediction network 560 generates a learning phase prediction for the future development of the input scene based on the learning phase feature set 131. Thereafter, the deviation of the learning phase prediction from the actual development of the input scene is determined. A realistic evaluation of the associated mode is then derived from the deviation—504. The weights of the backbone network 120 and/or the weights of the classifier network 140 and/or the weights of the untrained prediction network 560 are then modified such that a deviation between the learning phase evaluation and the realistic evaluation of the different modes is reduced—506.

The loss function may be designed here in the same way as in the case described above, in which only the classifier network 140 is trained in connection with the backbone network 120. However, θ now also includes the parameters of the SANs 560 so that these parameters are likewise trained.

In order to prevent the scenes predicted by the SANs to be trained from becoming too similar to one another, it is recommended to consider a further criterion when modifying the weights, namely, an entropy of the predicted scenes. In an advantageous variant of the training method, the weights of the backbone network and/or the weights of the classifier network and/or the weights of the at least one untrained prediction network are thus modified not only such that a deviation between the learning phase evaluation and the realistic evaluation of the different modes is reduced but also such that an entropy of the predictions of the prediction modules is increased. Again, all predictions, i.e., the predictions of the SANs to be trained as well as of the pre-trained and traditional prediction modules, are considered.

What is claimed is:

1. A method for training a computer-implemented system configured to predict future developments of a traffic scene, the system comprising:
a perception level configured to aggregate scene-specific information of an input scene;
a backbone network configured to generate a feature set of latent features based on the scene-specific information;
a classifier network configured to evaluate a specified number of different modes for the future developments of the input scene based on the feature set; and
a respective prediction module, for each mode, configured to generate a prediction for the future development of the input scene, the method comprising:
generating with the backbone network a learning phase feature set based on scene-specific training data;
generating with the classifier network a learning phase evaluation of the different modes based on the learning phase feature set;
generating with each respective prediction module a respective prediction for the future development of the input scene determined by the training data;
determining for each respective prediction module a deviation of the respective prediction from an actual development of the input scene and deriving from the deviation a realistic evaluation of the associated mode; and
training the backbone network and/or the classifier network by modifying weights of the backbone network and/or weights of the classifier network such that a deviation between the learning phase evaluation and the realistic evaluation of the different modes is reduced.

2. The method according to claim 1, wherein:
each respective prediction module generates, as a prediction of the future development of the input scene, a deterministic and/or probabilistic prediction trajectory for each traffic participant in the input scene as the future development of the input scene;
the deviations between the respective prediction trajectories and the actual trajectories of the traffic participants from the input scene are respectively determined; and
a realistic evaluation of the mode associated with the respective prediction modules is derived based on the determined deviations.

3. The method according to claim 1, wherein:
at least one of the respective prediction modules is realized in the form of a pre-trained prediction network or in the form of a model-based prediction module and generates a respective prediction for the future development of the input scene based on the training data.

4. The method according to claim 1, further comprising:
training at least one previously untrained prediction network, wherein:
the at least one untrained prediction network generates a network learning phase prediction for the future development of the input scene based on the training data and/or the learning phase feature set;
a deviation of the network learning phase prediction from the actual development of the input scene is determined and a realistic network evaluation of an associated mode is derived from the deviation; and
weights of the at least one untrained prediction network are modified such that a deviation between the network learning phase evaluation and the realistic network evaluation is reduced.

5. The method according to claim 4, wherein the weights of the backbone network and/or the weights of the classifier network and/or the weights of the at least one untrained prediction network are modified such that an entropy of the predictions of the prediction modules is increased.

6. A computer-implemented system configured to perform the training method according to claim 1.

7. A computer-implemented program product configured to perform the training method according to claim 1.
